(19) United States
(12) Patent Application Publication
(10) Pub. No.: US 2009/0074878 A1
(43) Pub. Date: Mar. 19, 2009

(54) Non-Toxic Water Soluble Inorganice Antimicrobal Polymer and Related Methods

(76) Inventors: Peter Lea, Toronto (CA); Al Siamon, Arroyo Grande, CA (US)

Correspondence Address: TRASK BRITT, P.O. BOX 2550, SALT LAKE CITY, UT, 84110, US

(21) Appl. No.: 11/887,988

(22) PCT Filed: Apr. 13, 2006
(86) PCT No.: PCT/CA2006/000571

§ 371 Date: Oct. 5, 2007

(30) Foreign Application Priority Data
Apr. 13, 2005 (CA) 2504014

(51) Int. Cl. A01N 59/26

(52) U.S. Cl. 424/605

(57) ABSTRACT

The present invention provides a non-toxic water soluble, inorganic anti-microbial polymer for inactivating microorganisms. The polymer is obtained by forming an aqueous solution comprising alkali metal cations, phosphate anions, carbonate anions, and hydrogen ions. The polymer has antimicrobial activity while in suspension and forms a hard, contiguous, encapsulating antimicrobial transparent film when dry. The film physically disrupts encapsulated microorganisms as it is formed and once formed does not support surface microbial growth.

### FIELD OF THE INVENTION

The present invention relates to non-toxic water soluble inorganic antimicrobial polymers and in particular to non-toxic water soluble inorganic antimicrobial polymers that can be used to inactivate microorganisms. The present invention also relates to methods for treating microorganisms with non-toxic water soluble inorganic antimicrobial polymers and to methods for preparing non-toxic water soluble inorganic antimicrobial polymers for inactivating microorganisms.

### BACKGROUND OF THE INVENTION

Several attempts have been made at developing compositions for inactivating microorganisms. A fundamental problem, however, with many of these compositions is that the active component is a toxic substance that has potentially harmful effects for humans and for other life forms not being treated by the composition.

For example, U.S. Pat. No. 6,869,620 to Moore at al., discloses a process for preparing concentrated aqueous solutions of biocidally active bromine and novel concentrated aqueous solutions that are useful precursors or intermediates for the production of biocidal solutions of active bromine. The process involves forming an acidic aqueous solution comprising alkali metal cations, bromide anions and sulfamate anions, feeding into the aqueous solution a source of alkali metal cations and chlorine-containing bromide oxidant and then raising the pH of the aqueous solution to at least about 10. However, bromine toxicity is well understood and demonstrated by its toxic effects in bacteria, algae and mollusks at concentrations of 5 wt % to 10 wt %.

U.S. Pat. No. 6,866,870 to Day, discloses a biocide composition with improved stability that is formed from a peroxide and a hypochlorite in a ratio of not less than 10:1. While the biocide composition has improved stability, it is however comprised of potentially toxic constituents.

U.S. Pat. No. 6,864,269 to Compadre et al., describes the use of concentrated, non-foaming solutions of quaternary ammonium compounds and particularly cetyl pyridinium chloride at about 40 wt % as an antimicrobial agent. This composition may also have toxic environmental effects.

U.S. Pat. No. 6,866,869 to Guthrie et al., discloses a liquid antimicrobial composition comprising a mixture of iodide anions and thiocyanate anions, periodic acid (or an alkali salt thereof) and optionally, a peroxidase. This composition may also have toxic environmental effects.

The toxic nature of biocidal compositions is also problematic in that they ultimately have limited effectiveness at reducing microbial contamination overall. In particular, the use of toxic compositions often results in the development of “super-bugs” as a direct consequence of mutations induced by toxic poisoning of the microorganism which leads to antibiotic resistance.

There therefore remains a need for a non-toxic antimicrobial agent that is useful for inactivating microorganisms and for decreasing the probability of further microorganism growth on the treatment surface.

### SUMMARY OF THE INVENTION

According to one aspect of the present invention, there is provided a non-toxic water soluble inorganic polymer for inactivating microorganisms.

According to another aspect of the present invention, there is provided a method of inactivating a microorganism by applying a coating solution comprising a non-toxic water soluble inorganic polymer. In a preferred embodiment, the method includes the further step of drying the aqueous solution to form a film.

The coating solution may be also be used as a fluid, film, gel or powder or as a constituent of a second solution, film, gel or powder.

According to a another aspect of the present invention, there is provided a process for preparing a non-toxic water soluble inorganic polymer comprising mixing an aqueous solution of alkali metal cations, phosphate anions, carbonate anions, and hydrogen ions to form an aqueous alkali solution.

According to another aspect of the invention, there is provided a non-toxic water soluble inorganic polymer of the following general formula, wherein X is any alkali metal cation, preferably sodium cation or potassium cation:

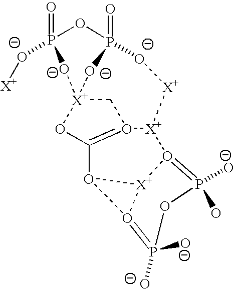

According to another aspect of the present invention, there is provided a film for inactivating microorganisms, said film comprising a non-toxic water soluble inorganic polymer.

According to a further aspect of the present invention, there is provided a polymer suspension for inactivating microorganisms, said polymer suspension comprising about 2% to about 20% water soluble inorganic polymer.

The present invention provides a non-toxic polymer that is effective in inactivating microorganisms including mold, fungus, spores, bacteria and virus, but is not harmful to the environment. The polymer is water soluble and is active in solution and as a dry film.

Other and preferred embodiments are described in the Detailed Description of the Preferred Embodiments together with examples and drawings described below.

### BRIEF DESCRIPTION OF THE DRAWINGS

In drawings which illustrate by way of example only a preferred embodiment of the invention

FIG. 1 is a graph showing the effect of the polymer of the present invention in liquid form on E. coli 0157:H7;

FIG. 2 is a graph showing the effect of the polymer of the present invention on E. coli 0157:H7 after drying;

FIG. 3 is a graph showing the concentration dependent effect of the polymer of the present invention after drying on pathogenic E. coli 0157:H7;

FIG. 4 is a graph showing the effect of the polymer of the present invention at lower concentration on E. coli 0157:H7 after drying;

FIG. 5 are scanning electron micrographs of E. coli 0157:H7 showing the effects of treatment with the polymer of the present invention;

FIG. 6 is a graph showing the effect of the polymer of the present invention on Salmonella after drying;

FIG. 7 is a graph showing the effect of the polymer of the present invention in liquid form on Salmonella;

FIG. 8 is a scanning electron micrograph of a Salmonella bacterium after treatment with the polymer of the present invention;

FIG. 9 is a scanning electron micrograph of the polymer of the present invention on cells infected with Feline Calicivirus;

FIG. 10 are photographs showing the effect of the polymer on contaminated paint; and,

FIG. 11 is a schematic drawing of the general structure of the polymer.

### DETAILED DESCRIPTION OF THE PREFERRED EMBODIMENTS

The present invention relates to non-toxic water soluble inorganic anti-microbial polymers that can be used to inactivate microorganisms.

In a preferred embodiment of the present invention, the non-toxic water soluble inorganic anti-microbial polymer is a polymer with a phosphate dimer—alkali metal backbone. The polymer has the following general structure as illustrated by the schematic drawings set out below.

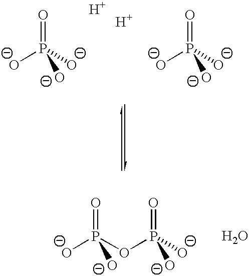

Phosphate dimers are formed by oxygen bonding of phosphate anions in the presence of hydrogen ions and water.

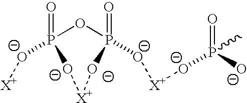

The phosphate dimers form polymeric structures by bonding with alkali metal ions, represented in the schematic drawing as X+, thereby providing a phosphate dimer—alkali metal backbone.

The polymer can exist as an aqueous suspension of intermediates or as a dry film. As free water is removed from the aqueous suspension, the polymeric intermediates are brought into intimate contact with one another thereby forming a complex polymeric film. The polymeric film is in the form of a sheet-like material joined by alkali metal—oxygen bonds as set out below.

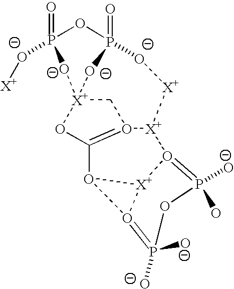

The polymer is prepared from an aqueous solution of alkali metal cations, phosphate anions, carbonate anions, and hydrogen ions. The alkali metal cations may be any group 1 alkali metal cations, preferably sodium or potassium cations.

The aqueous solution comprises preferably about 2 wt % to about 20 wt % of active polymer and is active between a pH 7 and 12. The aqueous solution will therefore contain a mixture of active polymer and alkali metal salts such as sodium bicarbonate, potassium bicarbonate, sodium carbonate, potassium carbonate, trisodium phosphate an tripotassium phosphate. Additionally the aqueous solution may contain phosphoric acid and diphosphates or higher oligophosphates. Preferably the aqueous solution comprises sodium carbonate (Na₂CO₃), trisodium phosphate (Na₃PO₄) and sodium biphosphate (Na₂HPO₄) in a molar ratio of 3.6:0.6:1, alternatively sodium carbonate (Na₂CO₃), trisodium phosphate (Na₃PO₄) and phosphoric acid (H₃PO₄) in a molar ratio of 10.8:3.8:1, further alternatively sodium bicarbonate (NHCO₃), sodium carbonate (Na₂CO₃) and trisodium phosphate (Na₃PO₄) in a molar ratio of 1:4:5, or potassium bicarbonate (KHCO₃), potassium carbonate (K₂CO₃) and tripotassium phosphate (K₃PO₄) in a molar ratio of 1:2.6:1.6. It will also be apparent to those skilled in the art, that the aqueous solution may contain other antimicrobial molecules of interest without deviating from the invention as claimed.

Dimerization and oligomerization of phosphate will be promoted in the aqueous solution with the addition of hydrogen ions, for example in the form of sodium bicarbonate (NaHCO₃), thereby promoting oxygen bond formation.

The polymer of the present invention is effective as an antimicrobial agent in multiphase formats. The phosphate dimer and oligomer intermediates of the polymer comprise antimicrobial properties while in aqueous solution as a suspension. Similarly, the polymer is effective while condensing (during oxygen bond formation), while forming a film, and when dry.

As a suspension, the phosphate dimer and oligomer intermediates render microorganisms inactive by biocidal interaction of the polymeric intermediates with microorganisms.

Preferably, the polymer functions during the drying process as the polymer condenses and forms a hard, transparent film. As the film is formed, the polymer acts as an antimicrobial agent by encapsulating microorganisms. As the film dries around the encapsulated microorganism, the physical force exerted by the process results in structural damage to the microorganism. This physical destruction is attributed partly to the film formation and also to the destructive effects of a biological matrix passing through water and meniscus surface tension during the final stages of drying.

As the film dries, it becomes bonded to the contact surface. In this form, it does not support further microbial growth. The film which remains on a surface after drying does not provide a suitable substrate for support, attachment, or growth of microorganisms on its surface as the prevalence of oxygen is displayed by the polymeric film and the resulting surface charge is not compatible with microorganisms. As such, the polymer inhibits further mutation and growth of inactivated microbes. As the film is water soluble, it may be washed away avoiding film build-up on surfaces.

The polymer may be applied to microorganisms as a coating in either fluid, film, gel or powder form. The polymer may be sprayed onto a surface, incorporated into a hydrogel such as agar to form a thick layer, or sprinkled on a surface in powder format. Various other applications will also be apparent to those skilled in the art.

The polymer preferably is applied to microorganisms as a coating solution which is then dried to form a film.

The polymer may also be applied to microorganisms as a constituent of another fluid, film, gel or powder. For example, the polymer has antimicrobial properties when incorporated into manufactured products, such as paint where the surface of a dried painted coating can enhance the properties of the polymer in the form of a polymeric film. Numerous other applications will be apparent to those persons skilled in the art.

The efficacy of the polymer of the present invention will be apparent from the ensuing examples which demonstrate the effects of the polymer on microorganisms, including bacteria, virus and fungi.

The list of microorganisms inactivated by the polymer, include at least the following:

| Bacteria: | Spray and Dry: |
|---|---|
| Escherichia coli, ATCC#35150 | No Growth |
| Pseudomonas aeruginosa, ATCC#15442 | No Growth |
| Salmonella choleraesuis, ATCC#10708 | No Growth |
| Salmonella choleraesuis, ATCC#14028 | No Growth |
| Salmonella choleraesuis, ATCC#6962 | No Growth |
| Salmonella choleraesuis, ATCC#8326 | No Growth |
| Staphylococcus aureus, ATCC#6538 | No Growth |
| Fungi | |
| Cryptococcus neoformans, ATCC#2344 | No Growth |
| Trichophyton mentagrophytes, ATCC#9533 | No Growth |
| Trichophyton mentagrophytes + Spores | No Growth |
| Mucor species + Conidia | No Growth |
| Black mold + Spores | No Growth |
| Pennicillium species + Spores | No Growth |
| Virus | |
| Feline Calicivirus, ATCC#VR-782 | No Growth |

### (Norwalk Virus Surrogate)

The following examples illustrate the various advantages of the preferred embodiments of the present invention.

### EXAMPLES

An alkali solution of about 2% polymer and sodium bicarbonate (NHCO₃), sodium carbonate (Na₂CO₃) and trisodium phosphate (Na₃PO₄) in a molar ratio of 1:4:5 was used for each of the following examples. This alkali solution of polymer is referred to as Concrobium.

Effect of Concrobium on E coli O157:H7

### Example 1

### Effect of Concrobium Suspension on E coli O157:H7

About five million colony forming units (CFU) of E coli O157:H7 #35150 were thoroughly mixed with 5 mL of Concrobium and incubated at room temperature. At 5, 10, 30, 60 and 180 minutes respectively, an aliquot of 100 μl was removed, diluted and plated on an agar plate. The plates were incubated at 37° C. overnight. Positive and negative control plates were also prepared of E coli in CASO (growth medium) (positive control) and Concrobium suspension alone (negative control).

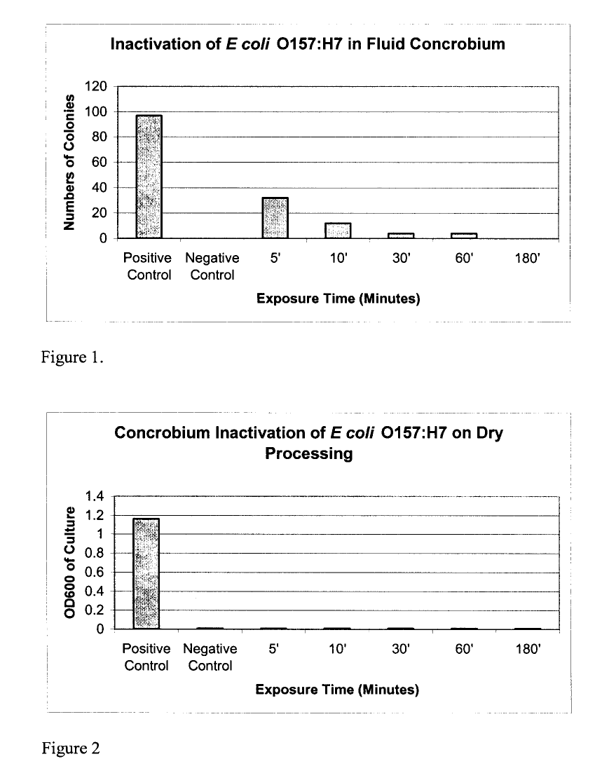

The growth of bacteria was determined by examining the number of colonies appearing on the agar plates after overnight incubation. As shown in the graph of FIG. 1, the E coli bacteria in the positive control group grew to full capacity, while the test plates treated with Concrobium resulted in lower E coli growth. E coli inhibition increased with increasing Concrobium exposure time. The test plate representing 180-minute exposure of Concrobium, showed no E coli colony growth indicating complete reduction in E coli growth after 180 minutes exposure to Concrobium suspension.

### Example 2

### Effect of Concrobium on E coli O157:H7 on Dried Surfaces

About five million CFU of E coli O157:H7 ATCC #35150 were thoroughly mixed with 5 mL of Concrobium and incubated at room temperature. At for 5, 10, 30, 60 and 180 minutes respectively, an aliquot of 100 μl was removed and spread onto the surface of a sterile Petri dish. The surfaces of the Petri dishes were air-dried for one hour under sterile conditions after which 10 mL of culture broth (CASO) was added to each dish. The dishes were incubated at 37° C. overnight.

The growth of bacteria was measured in a spectrometer at a wavelength of OD600 and compared to a positive control (same number of E coli in CASO) and a negative control (Concrobium with no bacteria added).

As shown in the graph of FIG. 2, the E coli bacteria in the positive control grew to full density, while the test samples treated with Concrobium resulted in minimal E coli growth. The test sample representing 5 minutes of exposure to Concrobium indicated no E coli growth indicating complete inactivation of E. coli by 5 minutes with Concrobium in dry form.

### Example 3

### Effect of Concentration of Concrobium on E coli O157:H7 on Dried Surfaces

About five million colony-forming units (CFU) of E coli O157:H7 #35150 were thoroughly mixed with 5 mL of each of the following and incubated at room temperature.

1. 0% Concrobium (CASO growth medium only)

### 2. 50% Concrobium (50% CASO)

### 3. 70% Concrobium (30% CASO)

### 4. 100% Concrobium (no CASO)

At 10, 60 and 120 minutes respectively, aliquots of 100 μl were plated onto the surface of a sterile Petri dish. The surfaces were air-dried for one hour under sterile conditions after which 10 mL of culture broth CASO was added to each dish. The dishes were incubated at 37° C. overnight. The growth of E coli bacteria was measured in a spectrometer at a wavelength of OD600.

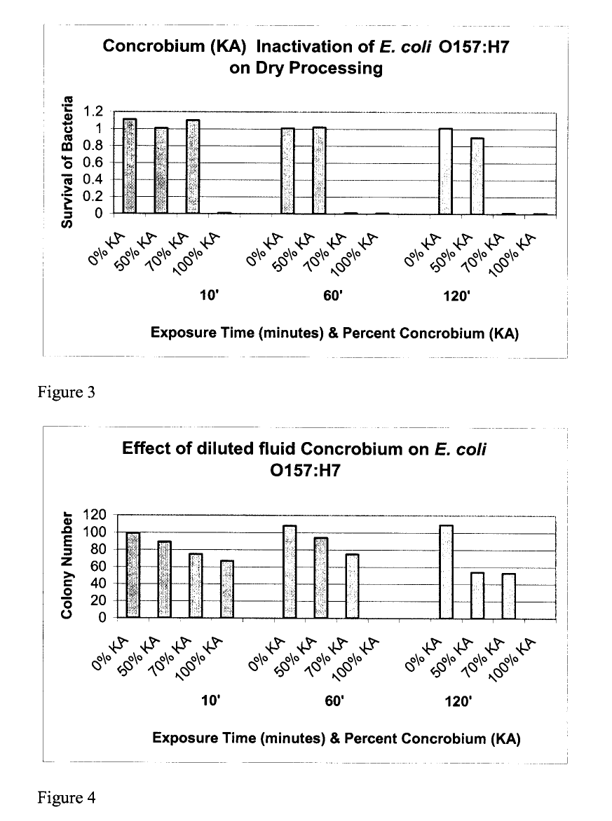

As shown in the graph of FIG. 3, 100% Concrobium (a 2% polymer solution) inhibited the growth of E coli at all three time points, while dilution of Concrobium with CASO (a polymer concentration of less than 2%) decreased its E coli inhibition effects.

### Example 4

### Effect of Concentration of Concrobium Suspension on E coli O157:H7

About five million colony-forming units (CFUs) of E coli O157:H7 #35150 were thoroughly mixed with 5 mL of each of the following and incubated at room temperature. At for 10, 60 and 120 minutes respectively, aliquots of 100 μl were diluted and plated on agar plates. The plates were incubated at 37° C. overnight. The growth of E coli was measured upon examination of colony growth after overnight incubation.

1. 0% Concrobium (CASO only)

### 2. 50% Concrobium (50% CASO)

### 3. 70% Concrobium (30% CASO)

### 4. 100% Concrobium (no CASO)

As shown in FIG. 4, the inhibitory effect of Concrobium was greatest at 100% concentration (a 2% polymer content) and decreased with increasing dilution. With 100% Concrobium, complete inactivation of E coli took place within 60 minutes of the bacteria being exposed to the Concrobium suspension.

### Example5

### Effect of pH on Concrobium Activity on E coli O157:H7

One million CFU of E coli O157:H7 were incubated with the following and samples of each were observed under a light microscope:

1. 1 mL of Concrobium, normal saline and 0.1 N (normal) sodium hydroxide
2. 1 mL of Concrobium and normal saline
3. 1 mL normal saline

The results showed that an alkaline solution of 0.1 N sodium hydroxide lysed the E. coli in suspension. However, neither Concrobium nor normal saline solution had a similar lysing effect on the E coli.

### Example 6

### Structure of Concrobium Activity on E coli on Dried Surfaces

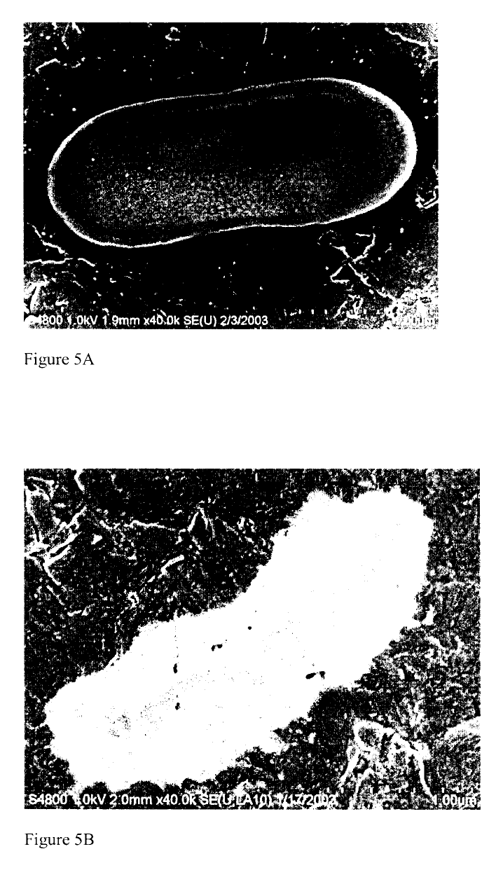

A high resolution scanning electron microscopy (SEM) study was performed on a sample of E coli incubated with CASO (FIG. 5A) and a sample of E coli incubated with Concrobium (FIG. 5B). The samples were dropped onto carbon specimen carrier platforms and allowed to air dry under sterile conditions. They were then examined under a scanning electron microscope at 40,000 magnification. As shown in FIG. 5, there was severe damage to the E coli cell wall and intracellular contents upon treatment with Concrobium. The E coli cell is enveloped by the Concrobium film layer which is observed on all surfaces of the E coli cell.

### Effect of Concrobium on Salmonella

Among the various pathogenic bacteria that are known to cause food-poisoning are members of the genus Salmonella. The ingestion of these organisms through contaminated food may lead to salmonellosis, a serious disease associated with gastroenteritis, typhoid, and parathyphoid. The following experiments were aimed to demonstrate that the water soluble inorganic antimicrobial polymer of the present invention also inhibits members of the Salmonella genus of bacteria. The test organisms were Salmonella choleraesuis serotypes Newport (Salmonella newport, ATCC#6962) and Heidelberg (Salmonella heidelberg, ATCC#8326), which are commonly reported in cases of food-poisoning.

### Example 7

### Effect of Concrobium on Salmonella on Dried Surfaces

About five million colony-forming units (CFU) of each of the Salmonella strains were thoroughly mixed with 5 mL of Concrobium and incubated at room temperature. At 10, 60 and 120 minutes, aliquots of 100 μl were removed from each tube and spread onto the surface of sterile Petri dishes. The surfaces of the Petri dishes were air-dried for one hour under sterile conditions after which 10 mL of culture broth CASO was added to each dish. The dishes were incubated at 37° C. overnight. The growth of bacteria was measured in a spectrometer at a wavelength of OD600 and compared to a positive control (same number of Salmonella in CASO).

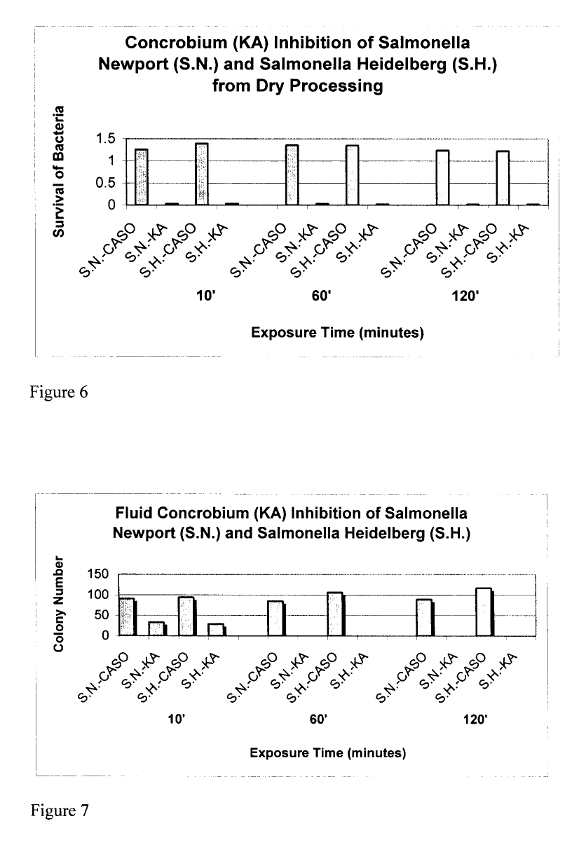

As shown by the graph of FIG. 6, the Salmonella bacteria in the positive control grew to full density, while the test samples treated with Concrobium resulted in minimal Salmonella growth. The test sample representing 10 minutes of exposure to Concrobium indicated no Salmonella growth indicating complete inactivation of Salmonella by 10 minutes with Concrobium in dry form.

### Example 8

### Effect of Concrobium Suspension on Salmonella

About five million colony-forming units (CFU) of each of the Salmonella strains were thoroughly mixed with 5 mL of Concrobium and incubated at room temperature. At 10, 60 and 120 minutes, aliquots of 100 μl were removed from each tube, diluted and plated onto agar plates. The plates were incubated at 37° C. overnight along with positive control plates prepared of Salmonella in CASO (growth medium).

The growth of Salmonella was determined by examining the number of colonies appearing on the agar plates after overnight incubation. As shown in the graph of FIG. 7, the Salmonella bacteria in the positive control group grew to full capacity, while the test plates treated with Concrobium resulted in lower Salmonella growth. The test plate representing 60-minute exposure of Concrobium, showed no Salmonella colony growth indicating complete reduction in Salmonella growth after 60 minutes exposure to Concrobium suspension.

### Example 9

### Morphology Change Viewed by SEM (Scanning Electron Microscopy)

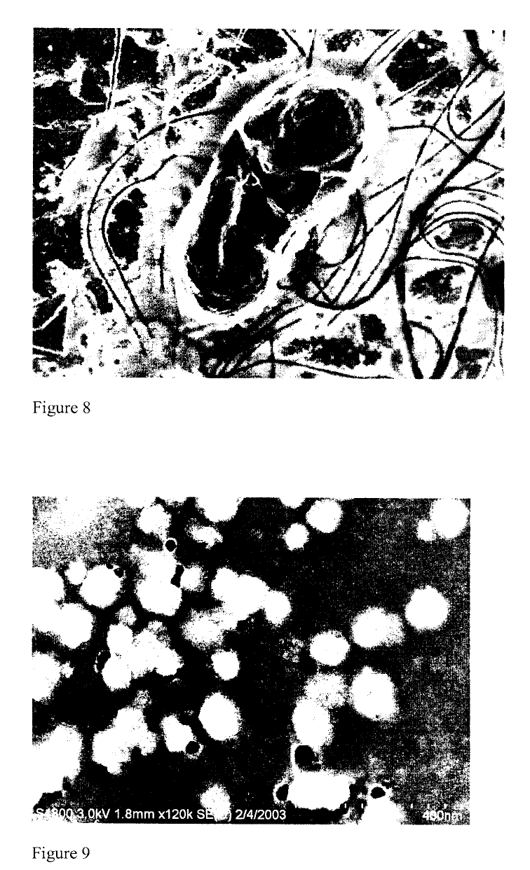

A high resolution SEM study was performed on a sample of Salmonella incubated with CASO and a sample of Salmonella incubated with Concrobium. The samples were dropped onto carbon specimen carrier platforms and allowed to air dry under sterile conditions. They were then examined under a scanning electron microscope at 40,000 magnification. The untreated Salmonella showed bacteria of normal size and intact cell wall while the SEM of the treated sample (shown in FIG. 8) showed physical changes to the Salmonella following Concrobium incubation. After Concrobium treatment, the Salmonella and its flagella was encased in the dried Concrobium film, resulting in morphological damage to the cell wall and contents.

### Example 10

### Effect of Concrobium on Carpet Contaminated with E coli or Salmonella

Several pieces of clean carpet (1 gram each) were contaminated with 10 million CFU of either E coli O157:H7 (ATCC #35150) or Salmonella, treated with CASO bacterial growth medium (positive control) or Concrobium and dried under sterile conditions. Samples were cultured overnight at 37° C. and treated according to Tables. 1 and 2.

TABLE 1
Decontamination of Carpets containing E. coli with Concrobium

| | E coli | | |
|---|---|---|---|
| Groups | O157:H7 | Treatment | Culture Results |
| 1 | Not added | Spraying with CASO and dry | No growth |
| 2 | Not added | Spraying with Concrobium and dry | No growth |
| 3 | 10⁷ CFU | Spraying with CASO and dry | Full growth |
| 4 | 10⁷ CFU | Soaking with CASO and dry | Full growth |
| 5 | 10⁷ CFU | Soaking with Concrobium and dry | NO GROWTH |

TABLE 2
Decontamination of Carpets containing Salmonella with Concrobium

| | Salmonella | | Culture |
|---|---|---|---|
| Groups | heidelberg | Treatment | Results |
| 1 | Not added | Soaking with CASO and dry | No growth |
| 2 | Not added | Soaking with Concrobium and dry | No growth |
| 3 | 10⁷ CFUs | Soaking with CASO and dry | Full growth |
| 4 | 10⁷ CFUs | Soaking with Concrobium and dry | NO |
| | | | GROWTH |

Tables 1 and 2 show that heavily contaminated carpets are decontaminated by application of Concrobium.

### Example 11

### Effect of Concrobium on Feline Calicivirus

The effect of Concrobium on cat Calicivirus, which is recognized as the equivalent or surrogate for the human form of Norwalk virus, was tested under the following conditions.

The infectivity of Feline Calicivirus (ATCC # VR-782) was tested by infecting the host cell line, feline kidney cell CRFK (ATCC #CCL-94), with the feline calicivirus.

The feline kidney cells were cultured to obtain sub-confluent cell monolayers and the following solution was added to the cultured cells:

1. Growth media alone (negative control, normal conditions for the cells);
2. Growth media with untreated Feline Calicivirus VR-782 (positive control); and,
3. Growth media with Concrobium-treated Feline Calicivirus VR-782.

The test cells were examined using SEM at 120,000 magnification. The results showed that under normal conditions, the epithelial cell line grew as an adherent monolayer on the surface of the culture dishes. However, when the cells were infected with the virus, a cytopathic effect occurred. Cells were detached from the dishes (indicating cell death) and no adherent cells could be observed. When the cells were exposed to fluid Concrobium and treated with virus, a clear adherent monolayer of kidney cells were observed and no infectivity from the treated virus could be detected. Concrobium inhibited primary viral infectivity. As shown in FIG. 9, the virus particles (light grey) are contained by the Concrobium film. The black holes are holes through the film, induced by the electron beam. A comparison of virus size indicates that the Concrobium film thickness covering the virus particles is about 40-70 nm.

The dry film thickness and polymer formation was confirmed by atomic force microscopy (AFM). The sample was sprayed onto a mica substrate and allowed to stand for 1 minute. Atomic force microscope profiling images were obtained with a SolverBio (NT-MDT, Moscow) operating in contact mode using a cantilever with nominal force constant of 0.58 N/m. The film thickness was measured as 60 nm +/−10nm.

### Example 12

### Effect of Concrobium on Pennicillium Growth

The inhibitory effect of Concrobium on mold growth was demonstrated by treating nine pieces of cloth fabric (2 cm by 1 cm) under the following conditions:

1. three pieces of cloth were soaked in Concrobium for one minute;
2. three pieces of cloth were soaked in PBS (phosphate buffered saline) for one minute;
3. three pieces of cloth were untreated.

After soaking, the cloth samples were put into a Petri dish and allowed to dry under sterile conditions overnight.

On day 2, the sterile cloth samples were inoculated with pennicillium. The inoculation volume of mold culture for all groups was as follows,

| | |
|---|---|
| Piece 1. | 0 μl, as negative control. |
| Piece 2. | 50 μl. |
| Piece 3. | 100 μl. |

All samples were left to dry under sterile condition overnight.

On day 3, 10 mL of YM mold growth medium was added to each Petri dish and all samples were incubated at room temperature for 6 days. The growth status of mold on the cloth was observed by eye and recorded in Table 3.

TABLE 3
Growth of Mold on Cloth

| | Mold Inoculation Volume (μl) | | |
|---|---|---|---|
| Groups | 0 | 50 | 100 |
| Group I - | No growth | No growth | No growth |
| Concrobium-treated | | | |
| Cloth | | | |
| Group II - PBS- | No growth | Mold covering half | Mold covering all |
| treated Cloth | | of the cloth | the cloth |
| Group III - Plain | No growth | Mold covering all | Mold covering all |
| Cloth | | the cloth | the cloth |

The results indicated that Concrobium inhibited mold growth on the cloth samples.

### Example 13

### Effect of Concrobium in Paint

50 mL of Concrobium was mixed with 50 mL of Designer's Flat Interior Latex Wall Paint. The total mixture was then reduced to 50 mL by heating and stirring. The original paint was used as a control.

Nine pieces of drywall, size of˜1.5 cm×3 cm, were tested as follows:

| | |
|---|---|
| Group 1. | three untreated drywall pieces. |
| Group 2. | three pieces drywall treated with 2 mL original paint |
| Group 3. | three pieces of drywall treated with 2 mL of Concrobium. |

The drywall pieces were dried under sterile conditions.

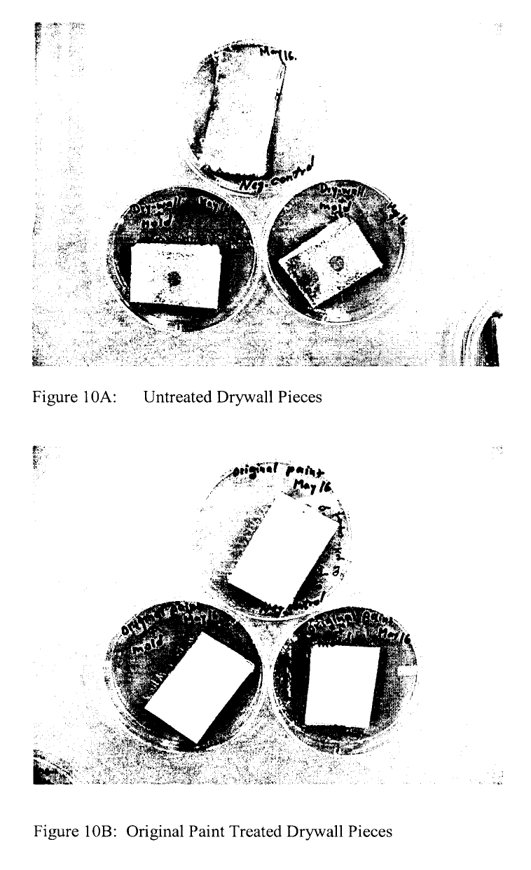

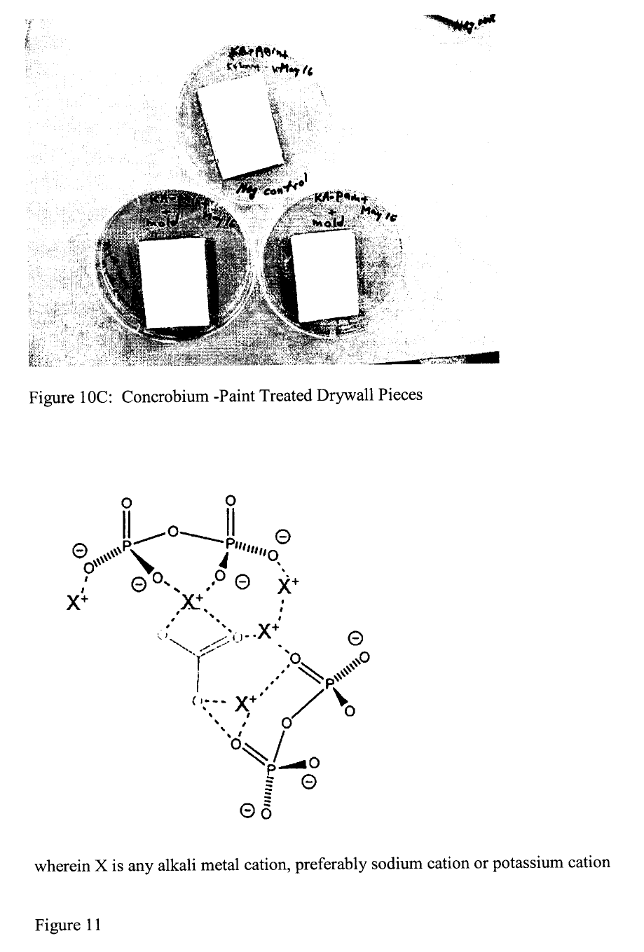

One piece from each group was used as a negative control (without adding black mold), and the two remaining pieces were exposed to 100 μl of black mold culture. Samples were kept in Petri dishes at 20° C. for three weeks and 1 mL of sterile water was added to each dish every two days to maintain the moisture. The results were recorded by photography as shown in FIG. 10. The photographs showed that mold grew on the untreated and original-paint-treated drywall pieces, but not on the Concrobium treated pieces.

Although the present invention has been shown and described with respect to its preferred embodiments and in the examples, it will be understood by those skilled in the art that other changes, modifications, additions and omissions may be made to the invention without departing from the substance and the scope of the present invention as defined by the attached claims.

1. A non-toxic water soluble inorganic polymer for inactivating microorganisms.

2. The non-toxic water soluble inorganic polymer of claim 1 wherein the polymer has the following general formula, wherein X is any alkali metal cation, preferably sodium cation or potassium cation:

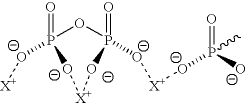

3. The non-toxic water soluble inorganic polymer of claim 2, wherein the polymer is in the form of a suspension.

4. The non-toxic water soluble inorganic polymer of claim 1 wherein the polymer has the following general formula, wherein X is any alkali metal cation, preferably sodium cation or potassium cation:

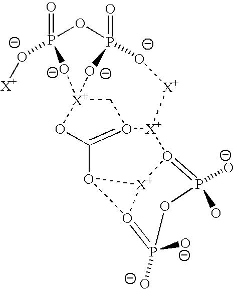

5. The non-toxic water soluble inorganic polymer of claim 4, wherein the polymer is in the form of a film.

6. A method of inactivating a microorganism by applying a coating solution comprising a non-toxic water soluble inorganic polymer.

7. The method of claim 6, where the non-toxic water soluble inorganic polymer has the following general formula, wherein X is any alkali metal cation, preferably sodium cation or potassium cation:

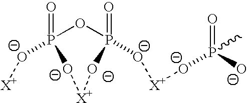

8. The method of claim 6 wherein the coating solution is in the form of a liquid.

9. The method of claim 6 wherein the coating solution is in the form of a gel.

10. The method of claim 6 further comprising the step of drying the coating solution to form a film or powder.

11. The method of claim 10, where the non-toxic water soluble inorganic polymer has the following general formula upon drying, wherein X is any alkali metal cation, preferably sodium cation or potassium cation:

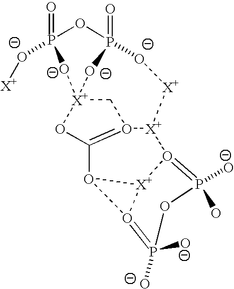

12. The method of claim 6, wherein the coating solution has a pH of between 7 and 12 and comprises from about 2 weight % to about 20 weight % of polymer.

13. The method of claim 6, wherein the coating solution further comprises additional antimicrobial molecules.

14. A process for preparing the non-toxic inorganic water soluble polymer of claim 1, said process comprising mixing alkali metal cations, phosphate anions, carbonate anions, and hydrogen ions to form an aqueous alkali solution.

15. The process of claim 14, wherein the alkali metal cations are any group 1 cations, preferably sodium cations or potassium cations.

16. The process of claim 14 wherein the alkali solution comprises sodium carbonate (Na₂CO₃), trisodium phosphate (Na₃PO₄) and sodium biphosphate (Na₂HPO₄) in a molar ratio of 3.6:0.6:1.

17. The process of claim 14 wherein the alkali solution comprises sodium carbonate (Na₂CO₃), trisodium phosphate (Na₃PO₄) and phosphoric acid (H₃PO₄) in a molar ratio of 10.8:3.8:1.

18. The process of claim 14 wherein the alkali solution comprises sodium bicarbonate (NHCO3), sodium carbonate (Na₂CO₃) and trisodium phosphate (Na₃PO₄) in a molar ratio of 1:4:5.

19. The process of claim 14 wherein the alkali solution comprises potassium bicarbonate (KHCO₃), potassium carbonate (K₂CO₃) and tripotassium phosphate (K₃PO₄) in a molar ratio of 1:2.6:1.6.

20. The process of claim 14 wherein the alkali solution comprises from about 2 wt % to about 20 wt % polymer.

21. A non-toxic water soluble inorganic polymer of the following general formula, wherein X is any alkali metal cation, preferably sodium cation or potassium cation:

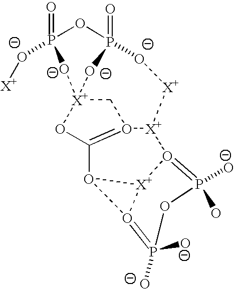

22. A film for inactivating microorganisms, said film comprising the non-toxic water soluble inorganic polymer of claim 1.

23. A method of inactivating a microorganism by encapsulating the microorganism with the film of claim 22.

24. A polymer suspension for inactivating microorganisms, said polymer suspension comprising about 2% to about 20% water soluble inorganic polymer.

25. A second solution or paint, film, gel or powder comprising the coating solution of claim 6 as a constituent.

26. (canceled)
